(19) United States
(12) Patent Application Publication
(10) Pub. No.: US 2005/0182863 A1
(43) Pub. Date: Aug. 18, 2005

(54) Direct memory access control

(75) Inventors: Christopher Edwin Wrigley, Saffron Waldon (GB); Patrick Gerard McGlew, Cambridge (GB); Andrew Burdass, Cambridgeshire (GB); Bruce Mathewson, Cambs (GB)

Correspondence Address: NIXON & VANDERHYE, PC, 901 NORTH GLEBE ROAD, 11TH FLOOR, ARLINGTON, VA, 22203, US

(73) Assignee: ARM LIMITED,, Cambridgeshire (GB)

(21) Appl. No.: 10/779,807

(22) Filed: Feb. 18, 2004

(51) Int. Cl. G06F 3/00

(52) U.S. Cl. 710/22; 710/20

(57) ABSTRACT

A direct memory access controller for controlling data transfer between a data source and a data destination comprising: a read/write port operable to receive data from said data source via a source bus and to output said received data to said data destination via a destination bus; wherein said direct memory access controller is operable in response to a predetermined number of clock pulses, to control said read/write port to output said received data said predetermined number of clock pulses after having received it. Also a direct memory access controller for controlling data transfer between a data source and a data destination comprising: a single read/write port comprising a read channel operable to receive data from said data source via a read path on a bus and a write channel operable to output said received data to said data destination via a write path on said bus, said read and write channel being operable to perform data reads and writes independently of each other.

### FIELD OF THE INVENTION

This invention relates to the field of data processing systems. More particularly, this invention relates to the field of direct memory access control.

### DESCRIPTION OF THE PRIOR ART

It is known to control the direct access to memory in one of two ways, both of which use a DMAC or direct memory access controller. FIG. 1 shows a “fly-by” direct memory access controller, in which memory from the source 10 to the destination 20 passes through a hard-wired data connection 30. Control signals sent through channels 35 by the DMAC 40 control the transfer of data along the connection 30. A disadvantage of this system is that it requires a special connection between the source and destination which reduces the flexibility of the system.

An alternative way of transferring data from a source memory 10 to a destination 20, is shown in FIG. 2. Here a bus 50 connects the source to the DMAC 40 and a bus 60 connects the destination to the DMAC 40. Data and control signals travel along the buses. As this system uses standard buses it is more flexible than the fly-by system. However, the DMAC 40 comprises registers 42 within a FIFO buffer to buffer the data sent from the source 40. Thus, a control signal is sent from the source and then a burst of data is sent and stored in the registers 42 within the DMAC 40. A control signal is also sent from the DMAC 40 to the destination and then when the burst of data has been received this burst of data is transferred from the registers 42 to destination 20. This buffering of the burst of data within the DMAC is costly in both hardware and in time. Furthermore control logic in state machines are required to control the sequencing of the transfer of data from the source to the FIFO and from the FIFO to the destination.

### SUMMARY OF THE INVENTION

Viewed from one aspect the present invention provides a direct memory access controller for controlling data transfer between a data source and a data destination comprising: a read/write port operable to receive data from said data source via a source bus and to output said received data to said data destination via a destination bus; wherein said direct memory access controller is operable in response to a predetermined number of clock pulses, to control said read/write port to output said received data said predetermined number of clock pulses after having received it.

The present invention recognises and addresses the above problems of lack of flexibility of the fly-by DMAC system and high hardware and time overheads of a DMAC system having a FIFO register buffer within it. It does this by providing a system that receives data from a data source and outputs it to a data destination after a predetermined number of clock cycles. Thus, the data is received and sent out independently of the amount or type of data received, simply in response to a predetermined number of clock cycles. This provides a system that can not only operate on a standard bus and does not require a special link, but also one that does not require a large amount of storage hardware within the controller. This is because the amount of data to be stored depends on the predetermined number of clock cycles and not on the data itself. Thus, the amount of data that is stored is both predictable and to some extent selectable depending as it does on the predetermined number of clock cycles chosen, thus hardware for storage of that amount of data can be provided.

In some embodiments, said predetermined number of clock pulses is one and said memory access controller comprises one register to store said received data during said one clock cycle prior to outputting it.

A single register within the DMAC and a single cycle delay enables the DMAC to meet design rules/constraints while providing a very limited storage space within the DMAC and thereby making savings on the hardware required.

Preferably, said predetermined number of clock pulses is one and said memory access controller comprises two registers arranged in parallel to each operable to store alternate items of said received data during a clock cycle prior to outputting said stored items.

By having buffer registers arranged in parallel, alternate data items can be stored in each of the registers, thereby avoiding the need to write from the buffer and read to it in the same clock cycle. In this case the through delay for data is still only one clock cycle, although in some embodiments additional control logic may be required.

In some embodiments said predetermined number of clock pulses is zero and said input port is connected to the output port, such that said received data is not stored within said direct memory access controller.

In this case, the data is sent straight through and there is no need for any hardware to store it. The downside of this is that it may be difficult owing to delays inherent in the system for this system to function correctly in certain cases.

Preferably, said DMAC further comprises combinatorial logic between said input and output port.

Combinatorial logic between the input and output port can be used to compensate for inherent delays within the system and may thereby enable the system to function correctly without any storage registers within the DMAC.

In some embodiments, said predetermined number of clock pulses is two and said memory access controller comprises an input register and an output register to store said received data during said two clock cycles prior to outputting it.

A further embodiment which is quite practical is to have input and output registers within the DMAC and a through delay for data of two clock cycles. This provides a good compromise between storage and cycle design constraints.

In preferred embodiments, said source bus and said destination bus comprise a single bus, said single bus comprising separate read and write paths, said read/write port comprising a single port having a read channel operable to read data from said read path, and a write channel operable to write data to said write path, such that data transfers from said data source to said read channel are received from said read path and data transfers to said data destination are output to said write path independently of said read path.

The use of a single bus having separate read and write paths provides a great deal of flexibility in the source and destinations that can be read to and written to independently of each other. This allows data bursts of different sizes to be transferred from source to destination with only a certain set number of clock cycles holding time within the DMAC.

Preferably, said read/write port further comprises a control channel operable to output control signals to a control path on said bus, said direct memory access controller further comprising control logic, said control logic being operable to generate at least one of the following control signals: a source control signal specifying at least one data transfer from said data source, said control channel of said read/write port being operable to output said source control signal to said data source via said control path on said bus prior to receiving said received data; and a destination control signal specifying said at least one data transfer to said data destination, said control channel of said read/write port being operable to output said destination control signal to said data destination via said control path on said bus independently of whether said received data has been received at said read/write port.

The provision of a separate control channel enables the control signal for the source burst of data and destination burst of data to be sent out independently and in some cases in advance of any of the data transfer enabling the data transfer to occur without any delay for control signals. In most embodiments there will be both source and destination control signals. However, in some embodiments where there is only a single source or destination, there will be no need for that source or destination control signal and it will be dispensed with.

Advantageously, said at least one data transfer comprises a sequence of data transfers from a plurality of consecutive addresses, said control logic being operable to generate single read and write control signals to respectively control each read and write of said sequence of data transfers from said data source.

The ability to send the control signal and the read and write data separately on separate channels means that a single control signal can be sent in some embodiments for each read or write of a burst of data which can improve efficiency and speed of transfer. In other embodiments data is not sent in bursts and the data is transparent as a series of single items.

Although, said single control signal can control a sequence of data transfers from a consecutive sequence of addresses starting at the first address, in some embodiments said single source control signal controls said sequence of data transfers from said plurality of consecutive addresses to be transferred from an essential address first, said transfer wrapping round to send data from said initial address following sending data from said final address of said consecutive addresses.

The single source control signal is not limited to controlling the sending of data one address after the other but can send it from the middle of a set of addresses wrapping round back to the beginning. This provides flexibility in the way the data is transferred. Further flexibility is provided in other embodiments where a data sequence may originate from a static non-incrementing address, or the increment may be non-uniform.

Preferably, said control logic is operable to generate a single destination control signal to control writing of said sequence of data transfers to said data destination.

Although, the data items in a sequence of data transfers can be controlled by individual control signals, it may be more efficient if the whole sequence is controlled by a single signal.

In some embodiments said data source and said data destination each comprise one of either a memory and a peripheral.

Data can be transferred between different units within a data processor, such as memory and peripherals.

A second aspect of the present invention provides a direct memory access control method for controlling data transfer between a data source and a data destination comprising the steps of: receiving data from said data source via a source bus at a read/write port; detecting a predetermined number of clock pulses; in response to said detected predetermined number of clock pulses, controlling said read/write port to output said received data to said data destination via a destination bus said predetermined number of clock pulses after having received it.

Preferably, said predetermined number of clock pulses is one and said received data comprises n data items, said method comprising the further steps of: (i) storing a first data item of said received data in one of two registers arranged in parallel during one clock cycle; (ii) outputting said data item stored during said previous clock cycle from one of said two registers and storing a further data item in said other of said two registers during a subsequent clock cycle, wherein step (ii) is performed n−1 times, and (iii) outputting the last data item of stored data during a further subsequent clock cycle.

By having buffer registers arranged in parallel, alternate data items can be stored in each of the registers, thereby avoiding the need to write from a buffer and read to it in the same clock cycle. Depending on the number of data items in a burst of data, step (ii) is performed any number of times, including zero, when the burst contains a single data item.

A third aspect of the present invention provides a computer program product, which is operable when run on a data processor to control the data processor to perform the steps of the method according to the second aspect of the present invention.

A further aspect of the present invention provides a direct memory access controller for controlling data transfer between a data source and a data destination comprising: a single read/write port comprising a read channel operable to receive data from said data source via a read path on a bus and a write channel operable to output said received data to said data destination via a write path on said bus, said read and write channel being operable to perform data reads and writes independently of each other.

The provision of a direct memory access controller that has a single port for inputting and outputting the data from a memory access to independent channels on a single bus, reduces bus latency, in that it does not limit the transfer of data to sources and destinations that are located on different buses, but allows data transfers between a source and destination located on the same data bus. Furthermore, the design requires fewer registers than a traditional DMA design and thus less power is required for operation.

A yet further aspect of the present invention provides a direct memory access control method for controlling data transfer between a data source and a data destination comprising the steps of: receiving at a read channel of a single read/write port data from said data source via a read path on a bus; and outputting said received data from a write channel of said single read/write port to said data destination via a write path on said bus; wherein said read and write channel perform data reads and writes independently of each other.

A still further aspect of the present invention provides a computer program product, which is operable when run on a data processor to control the data processor to perform the steps of the method according to the yet further aspect of the present invention.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates a fly-by direct memory access controller according to the prior art;

FIG. 2 schematically illustrates a direct memory access controller according to the prior art;

FIG. 3 schematically illustrates a “fly-through” direct memory access controller having a single register according to an embodiment of the present invention;

FIG. 4 shows a timing diagram illustrating the delay for data passing through the fly-through direct memory access controller according to the embodiment of FIG. 3;

FIG. 5 schematically illustrates a “fly-through” direct memory access controller having two registers in parallel according to an embodiment of the present invention;

FIG. 6 shows a timing diagram illustrating the delay for data passing through the fly-through direct memory access controller according to the embodiment of FIG. 5;

FIG. 7 schematically illustrates a “fly-through” direct memory access controller having a two registers in series according to an embodiment of the present invention;

FIG. 8 schematically illustrates a “fly-through” direct memory access controller having no registers according to an embodiment of the present invention; and

FIG. 9 illustrates a further embodiment of a direct memory access controller wherein the source and destination are on different buses according to an embodiment of the present invention; and

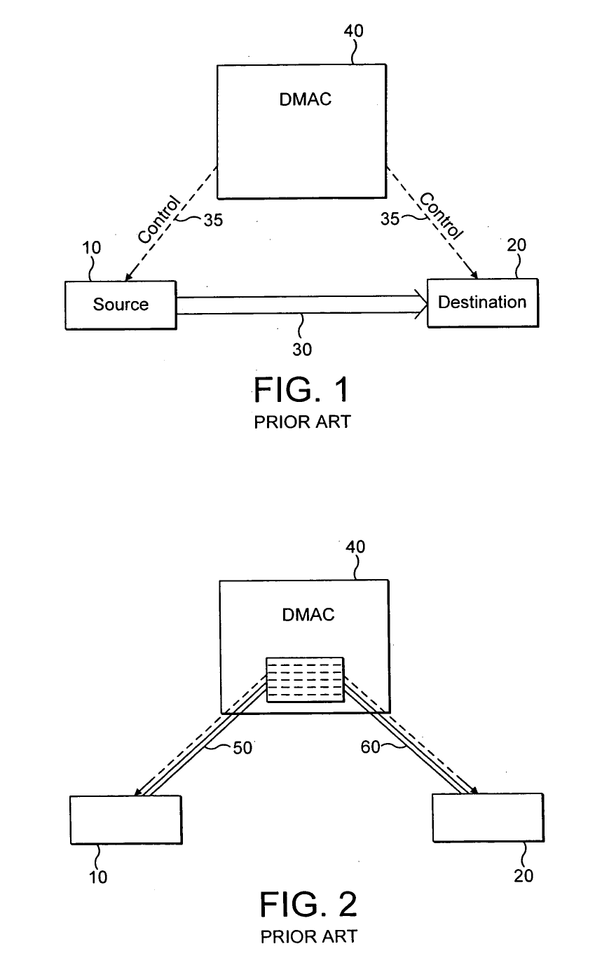

### DESCRIPTION OF THE PREFERRED EMBODIMENTS

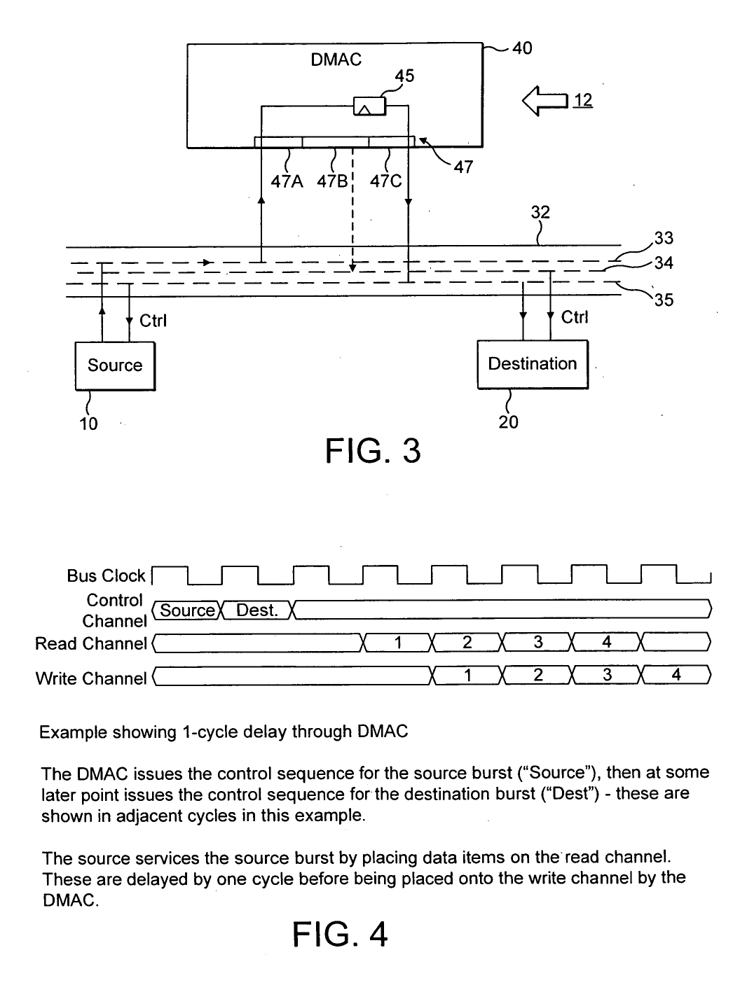

FIG. 3 shows a source 10 and destination 20 which are both connected to the same data bus 32. This data bus has three separate channels which can operate independently of each other. These three channels are a read channel 33, a control channel 34 and a write channel 35. In this embodiment we have used the term read channel to indicate a channel for transferring data to the DMAC, i.e. data being read by the DMAC and a write channel to indicate a channel for transferring data from the DMAC 40, i.e. being written by the DMAC 40. The source and destination both include data storage locations which can include registers, memory or caches. These can be located on a memory or on a peripheral of some sort.

The DMAC, direct memory access controller 40, controls data transfers between the data source 10 and the data destination 20 in response to a data access instruction 12. It comprises a single read/write port 47 which has three channels, a read channel 47a, a control channel 47b and a write channel 47c. Furthermore, the DMAC 40 comprises a register 45 for storing data that is received at the read channel prior to outputting it via the write channel.

When a data access instruction 12 has been received by the DMAC 40, the DMAC 40 issues a control signal to the source from the control channel 47b of the input/output port 47 via the control channel 34 of the bus 32. This control signal controls the output of a burst of data indicated by the data access instruction from the source. The DMAC 40 will also issue a destination control signal from control channel 47b to control channel 34 of bus 32. This is sent to the destination 20. This control signal can be sent before the DMAC receives any data.

Thus, following receipt of a source control signal by the source, data is sent from source 10 via read channel 33 to the read channel 47a of the input/output port 47 of the DMAC 40. Once one item of the data has been received at the DMAC 40 it is stored in the register 45, and is then output at the next clock cycle via the write channel 47c of the input/output port 47 via write channel 35 to destination 20. During this clock cycle the next item of data within the data burst will be received at the read channel 47a and stored in the register 45. Thus, in this embodiment, there is a single register for storing one item of data and the DMAC controls the data transfer such that it is stored in that one register for one clock cycle and then sent on. It is able to do this owing to having separate read/write channels on the data bus.

The burst of data that is transferred in response to a single control signal may comprise a single data item but may also comprise a plurality of data items. These may be located in concurrent addresses the control signal indicating that data lying in addresses located between two addresses is to be sent. The signal may control the source to send the data items starting at any of the addresses and then moving concurrently through them, possibly wrapping round to the initial address from the final address of the sequence if the first data item to be sent was from one of the middle addresses. In other embodiments, the data sequence may originate from a static (non-incrementing) address, or alternatively the increment may be non-uniform (“striping” of a data region).

FIG. 4 shows a timing diagram of the data transfer of the DMAC according to FIG. 3a. As can be seen, the DMAC 40 issues a control sequence for the source burst (“source”) in the first clock cycle and then at some later point, in this example, in the next clock cycle, it issues a control sequence for the destination burst (“DEST”). These are sent out on the control channel 47b of the input/output port 47 of the DMAC and are carried along the control channel 34 of the bus 32. The source 10 then reacts to the source control burst by placing data items (1, 2, 3, 4) on the read channel 33 of the data bus 32 and these are received at the read channel 47a of the input/output port with DMAC 40. These are then stored in register 45 for one clock cycle and are output on the write channel 35 in the next clock cycle. Thus, data item 1 is received in one clock cycle and output on the next, data item 2 being received in the next clock cycle and output in the one after that.

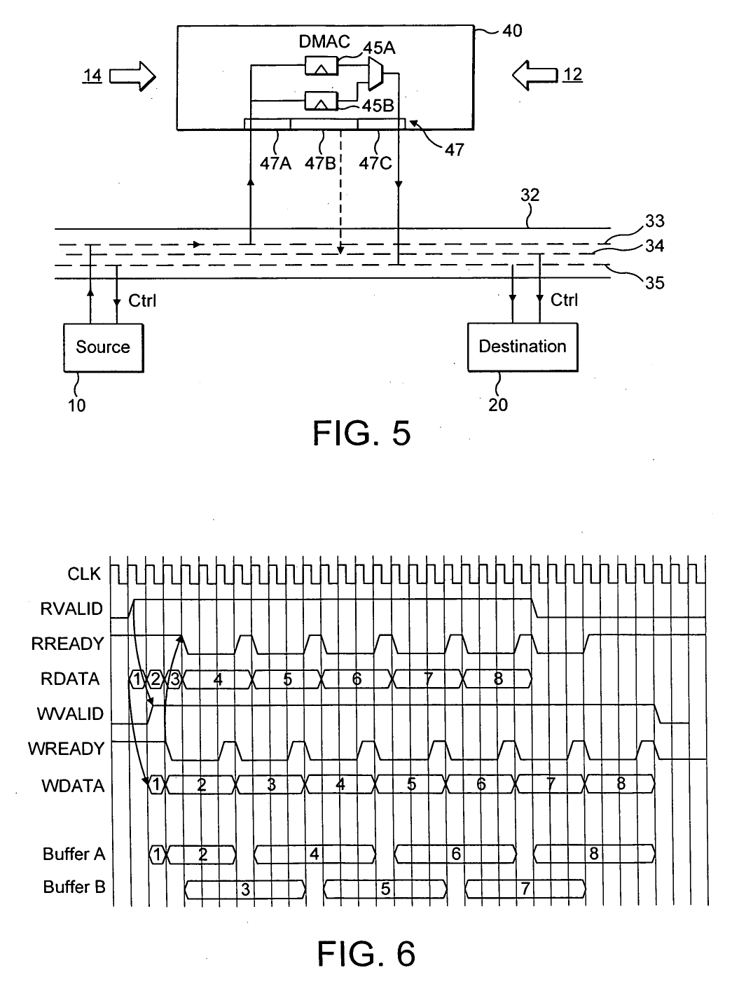

FIG. 5 shows a DMAC similar to that shown in FIG. 3, but in this case there are two storage registers in parallel. Thus, the first data item is stored in register 45A and the next in register 45B and so on. This avoids any potential problems in the timing that ay arise if one attempts to read from and write to a register in the same clock cycle. The DMAC is activated by receipt of a “START” command 12, and then on receipt of a “DMA request from a peripheral” 14, it sends out control signals along control channel 34 to control the reading and writing of data.

FIG. 6 shows a timing diagram showing the transfer of data and control signals to and from the DMAC of FIG. 5. In this figure, RDATA is the read data bus. RVALID indicates clock cycles in which valid data is driven onto RDATA by the read data source. RREADY indicates clock cycles in which data can be accepted from RDATA by the data destination (in this case, the DMAC). WDATA is the write data bus. WVALID indicates clock cycles in which valid data is driven onto WDATA by the write data source (in this case, the DMAC). WREADY indicates clock cycles in which data can be accepted from WDATA by the data destination. FIG. 5 is an example illustration of fly-through DMA, whereby the DMAC 40 issues both the read and write control information, then acts as a simple conduit from the read channel to the write channel before commencing the write transactions. Note that due to the independence of the bus channels this can be achieved with a single master port.

Assuming that no combinatorial through paths are allowed (i.e. can not connect WREADY direct to RREADY) then 2 register buffers are needed (registers 45A and 45B here set in parallel buffer formation) unless bandwidth can be sacrificed by only registering new incoming data once the previous has been clocked out (note this would take 2 cycles per data item on zero-wait memory-memory transfers).

For memory-to-memory transfers, there is no need for the DMAC 40 to wait for a DMA request from a peripheral before commencing the transfers. Therefore, once the DMAC 40 has been programmed and a “start” command has been issued to the DMAC, the DMAC immediately requests the use of the bus. Once granted, the address transaction for both the first DMA read burst and the first DMA write burst are transmitted. As read data transactions are received, they are passed through very little internal buffering involving storage for a single clock cycle and are then transmitted as write data transactions.

For memory-to-peripheral transfers DMA write accesses do not commence until a DMA request is received from the peripheral.

In peripheral-to-memory transfers the channel first waits for a DMA request from the peripheral before requesting the bus. Once granted, the address transaction for both the first DMA read burst and the first DMA write burst are transmitted.

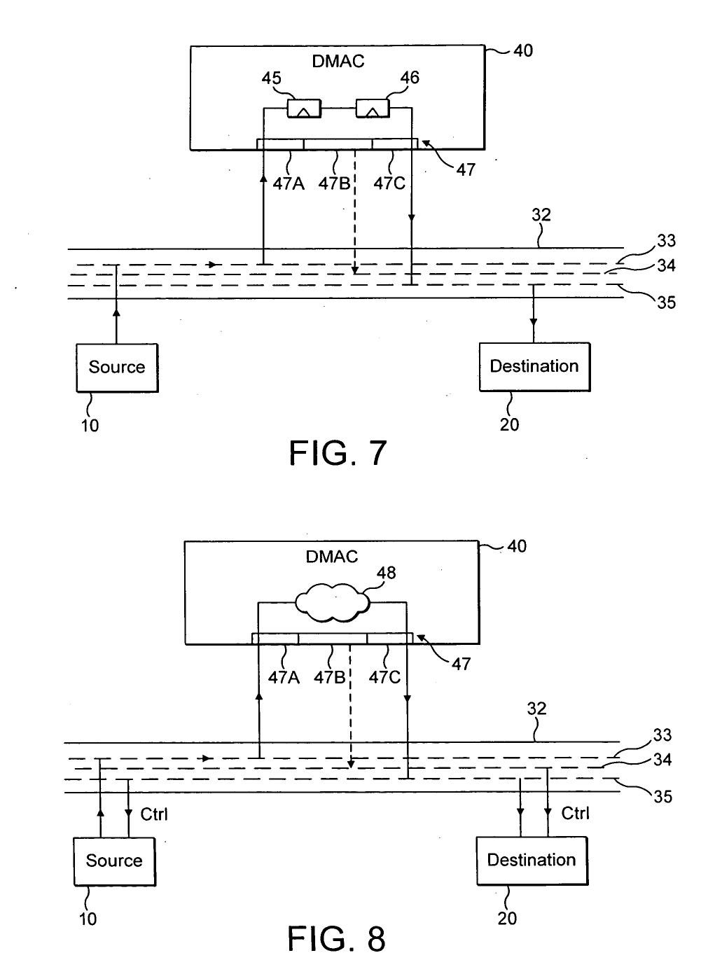

FIG. 7 shows an alternative embodiment wherein there are two registers 45 and 46 in series and the data is stored for two clock cycles prior to being output. Clearly, there could be any number of registers corresponding to any number of clock cycles for storing the data. The important issue is that the number of registers required is independent of the size of the data burst. In other words, an N-deep register bank is required for any payload, where N is the number of clock cycles that the data is stored for.

FIG. 8 shows a DMAC 40 with no buffer registers. In this embodiment the read and write data channels are connected entirely by combinatorial logic 48. Thus, the data passes straight through the DMAC with minimal delay. This can be useful in low frequency operations.

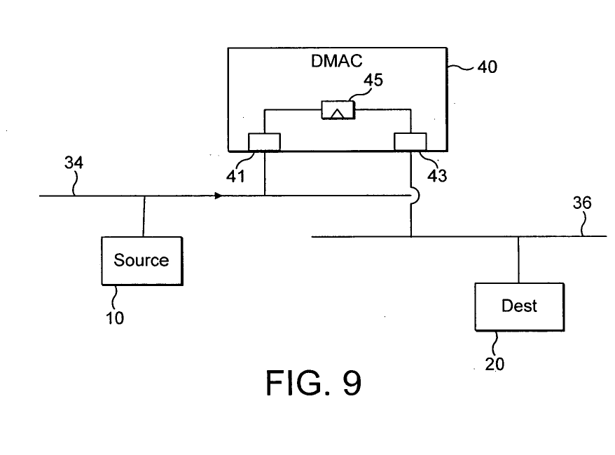

FIG. 9 shows an example of a DMAC 40 servicing two different busses 34 and 36. In this case there is not one bus with separate read and write channel on which the source and destination are located, rather the source and destination are located on different busses. In order for this to work, the DMAC 40 requires two ports, a read port 41 and a write port 43. A register 45 stores the data for one clock cycle that is input from the source 10 and outputs it to the destination 20 in the next clock cycle. Clearly it would be possible to include further registers within the DMAC and to store data for more clock cycles as appropriate.

Thus, fly-through DMA means that a low amount of buffering is implemented between the DMA read and write data transfers effectively chaining them together. Thus, the read and write bursts proceed concurrently, and bus wait states on one cause wait states on the other.

Although a particular embodiment of the invention has been described herein, it will be apparent that the invention is not limited thereto and that many modifications and additions may be made within the scope of the invention. For example, various combinations of the features of the independent claims could be made with the features of the dependent claims without departing from the scope of the present invention.

1. A direct memory access controller for controlling data transfer between a data source and a data destination comprising:
a read/write port operable to receive data from said data source via a source bus and to output said received data to said data destination via a destination bus; wherein
said direct memory access controller is operable in response to a predetermined number of clock pulses, to control said read/write port to output said received data said predetermined number of clock pulses after having received it.

2. A direct memory access controller according to claim 1, wherein said predetermined number of clock pulses is one and said memory access controller comprises a register to store said received data during said one clock cycle prior to outputting said received data.

3. A direct memory access controller according to claim 1, wherein said predetermined number of clock pulses is one and said memory access controller comprises two registers arranged in parallel to each other, each operable to store alternate items of said received data during a clock cycle prior to outputting said stored items.

4. A direct memory access controller according to claim 1, wherein said predetermined number of clock pulses is zero, and said input port is connected to said output port, such that said received data is not stored within said direct memory access controller.

5. A direct memory access controller according to claim 4, further comprising combinatorial logic between said input and said output port.

6. A direct memory access controller according to claim 1, wherein said predetermined number of clock pulses is two and said memory access controller comprises an input register and an output register to store said received data during said two clock cycles prior to outputting it.

7. A direct memory access controller according to claim 1, wherein said source bus and said destination bus comprise a single bus, said single bus comprising separate read and write paths, said read/write port comprising a single port having a read channel operable to read data from said read path and a write channel operable to write data to said write path, such that data transfers from said data source to said read channel are received from said read path and data transfers to said data destination are output to said write path independently of said read path.

8. A direct memory access controller according to claim 1, said read/write port further comprising a control channel operable to output control signals to a control path on said bus, said direct memory access controller further comprising:
control logic, said control logic being operable to generate at least one of the following control signals:
a source control signal specifying at least one data transfer from said data source, said control channel of said read/write port being operable to output said source control signal to said data source via said control path on said bus prior to receiving said received data; and
a destination control signal specifying said at least one data transfer to said data destination, said control channel of said read/write port being operable to output said destination control signal to said data destination via said control path on said bus independently of whether said received data has been received at said read/write port.

9. A direct memory access controller according to claim 8, wherein said at least one data transfer comprises a sequence of data transfers from a plurality of consecutive addresses, said control logic being operable to generate single read and write control signals to respectively control each read and write of said sequence of data transfers from said data source.

10. A direct memory access controller according to claim 9, wherein said single source control signal controls said sequence of data transfers from said plurality of consecutive addresses to be transferred from a central address first, said transfer wrapping round to send data from said initial address following sending data from said final address of said consecutive addresses.

11. A direct memory access controller according to claim 10, said control logic being operable to generate a single destination control signal to control writing of said sequence of data transfers to said data destination.

12. A direct memory access controller according to claim 1, wherein said data source and said data destination each comprise one of either a memory and a peripheral.

13. A direct memory access controller for controlling data transfer between a data source and a data destination comprising:
a single read/write port comprising a read channel operable to receive data from said data source via a read path on a bus and a write channel operable to output said received data to said data destination via a write path on said bus, said read and write channel being operable to perform data reads and writes independently of each other.

14. A direct memory access controller according to claim 13, said direct memory access controller further comprising control logic, said control logic being operable:
to generate a source control signal specifying at least one data transfer from said data source, said read/write port further comprising a control channel, operable to output control signals along a control path of said bus, said control channel being operable to output said source control signal to said data source prior to receiving said received data at said read channel; and
to generate a destination control signal specifying said at least one data transfer to said data destination, said control channel being operable to output said destination control signal to said data destination independently of whether said received data has been received at said read channel.

15. A direct memory access controller according to claim 13, wherein said at least one data transfer comprises a sequence of data transfers from a plurality of consecutive addresses, said control logic being operable to generate a single source control signal to control sending of said sequence of data transfers from said data source.

16. A direct memory access controller according to claim 15, said control logic being operable to generate a single destination control signal to control writing of said sequence of data transfers to said data destination.

17. A direct memory access control method for controlling data transfer between a data source and a data destination comprising the steps of:
receiving data from said data source via a source bus at a read/write port;
detecting a predetermined number of clock pulses;
in response to said detected predetermined number of clock pulses, controlling said read/write port to output said received data to said data destination via a destination bus said predetermined number of clock pulses after having received it.

18. A direct memory access control method according to claim 17, wherein said predetermined number of clock pulses is one and said method comprises the further step of storing said received data in a register during said one clock cycle prior to outputting it.

19. A direct memory access control method according to claim 17, wherein said predetermined number of clock pulses is one and said received data comprises n data items, said method comprising the further steps of:
(i) storing a first data item of said received data in one of two registers arranged in parallel during one clock cycle;
(ii) outputting said data item stored during said previous clock cycle from one of said two registers and storing a further data item in said other of said two registers during a subsequent clock cycle, wherein step (ii) is performed n−1 times, and
(iii) outputting the last data item of stored data during a further subsequent clock cycle.

20. A direct memory access control method according to claim 17, wherein said predetermined number of clock pulses is zero, and said read/write port is controlled to output said received data after having received it, without storing it.

21. A direct memory access control method according to claim 17, wherein said predetermined number of clock pulses is two and said method comprises the further step of storing said received data in an input register during one clock cycle and storing said received data in an output register during a subsequent clock cycle prior to outputting it.

22. A direct memory access control method according to claim 17, wherein said source bus and said destination bus comprise a single bus, said single bus comprising separate read and write paths, said read/write port comprising a single port having a read channel operable to read data from said read path and a write channel operable to write data to said write path, said method controlling said read channel to receive data transfers from said data source via said read path, and controlling said write channel to output said received data to said data destination via said write path independently of said read path.

23. A direct memory access control method according to claim 17, said method comprising the further step of generating at least one of the following control signals:
a source control signal specifying at least one data transfer from said data source and controlling a control channel of said read/write port to output said source control signal to said data source via a control path on said bus prior to receiving said received data; and
a destination control signal specifying said at least one data transfer to said data destination, and controlling a control channel of said read/write port to output said destination control signal to said data destination via said control path on said bus independently of whether said received data has been received at said read/write port.

24. A direct memory access control method according to claim 23, wherein said at least one data transfer comprises a sequence of data transfers from a plurality of consecutive addresses, said method generating a single source control signal to control sending of said sequence of data transfers from said data source.

25. A direct memory access control method according to claim 24, wherein said single source control signal controls said sequence of data transfers from said plurality of consecutive addresses to be transferred from a central address first, said transfer wrapping round to send data from said initial address following sending data from said final address of said consecutive addresses.

26. A direct memory access control method according to claim 24, said method generating a single destination control signal to control writing of said sequence of data transfers to said data destination.

27. A direct memory access control method according to claim 17, wherein said data source and said data destination each comprise one of either a memory and a peripheral.

28. A direct memory access control method for controlling data transfer between a data source and a data destination comprising the steps of:
receiving at a read channel of a single read/write port data from said data source via a read path on a bus; and
outputting said received data from a write channel of said single read/write port to said data destination via a write path on said bus; wherein
said read and write channel perform data reads and writes independently of each other.

29. A direct memory access control method according to claim 28, said method further comprising the steps of:
generating a source control signal specifying at least one data transfer from said data source and controlling a control channel of said read/write port to output said source control signal to said data source via a control path on said bus prior to receiving said received data; and
generating a destination control signal specifying said at least one data transfer to said data destination, and controlling a control channel of said read/write port to output said destination control signal to said data destination via said control path on said bus independently of whether said received data has been received at said read/write port.

30. A direct memory access control method according to claim 29, wherein said at least one data transfer comprises a sequence of data transfers from a plurality of consecutive addresses, said method generating a single source control signal to control sending of said sequence of data transfers from said data source.

31. A direct memory access control method according to claim 30, said method generating a single destination control signal to control writing of said sequence of data transfers to said data destination.

32. A computer program product, which is operable when run on a data processor to control the data processor to perform the steps of the method according to claim 17.
